(19) United States
(12) Patent Application Publication
(10) Pub. No.: US 2019/0301577 A1
(43) Pub. Date: Oct. 3, 2019

(54) VEHICLE POWER UNIT

(71) Applicant: Aisin Seiki Kabushiki Kaisha, Kariya-shi (JP)

(72) Inventor: Shinya Harada, Chiryu-shi (JP)

(73) Assignee: Aisin Seiki Kabushiki Kaisha, Kariya-shi (JP)

(21) Appl. No.: 16/238,559

(22) Filed: Jan. 3, 2019

(30) Foreign Application Priority Data
Mar. 30, 2018 (JP) 2018-068486

(51) Int. Cl. F16H 37/08; F16H 3/10; F16H 3/089; F16H 61/02

(52) U.S. Cl. CPC F16H 37/0813; F16H 3/10; F16H 2063/3093; F16H 61/0213; F16H 3/089

(57) ABSTRACT

A vehicle power unit includes: an electric motor; an input shaft to which power of the electric motor is input; an intermediate shaft to which the power from the input shaft is transmitted; a drive shaft which is disposed parallel to the intermediate shaft, to which the power from the intermediate shaft is transmitted via a differential mechanism unit, and which transmits the power to drive wheels; a speed changer mechanism unit disposed on a power transmission path and including gear pairs, a switching unit, and a one-way clutch; and a control unit which selects main control in which the switching unit is instructed to be disposed at a neutral position or a position where the switching unit engages with the gear pair, or auxiliary control in which the switching unit is instructed to be forcedly disposed at a position where the switching unit engages with the gear pair.

### CROSS REFERENCE TO RELATED APPLICATIONS

This application is based on and claims priority under 35 U.S.C. § 119 to Japanese Patent Application 2018-068486, filed on Mar. 30, 2018, the entire contents of which are incorporated herein by reference.

### TECHNICAL FIELD

This disclosure relates to a vehicle power unit which includes a speed changer mechanism unit which transmits power of an electric motor to drive wheels.

### BACKGROUND DISCUSSION

In the related art, there is known a vehicle which uses an electric motor as a drive source, for example, an electromotive four-wheel drive vehicle (an electromotive 4WD), an electric vehicle (EV), or the like which drives main drive wheels using an engine and drives a driven wheel using an electric motor. A power transmission device (a trans-axle) including a reduction mechanism unit and a differential mechanism unit for increasing the power of the electric motor which serves as the drive source and transmitting the increased power to the drive wheel side is generally installed in such a vehicle.

JP 2016-22799A (Reference 1) discloses a general vehicle power unit which is configured to include a motor unit including a motor and a trans-axle. More specifically, there is disclosed a vehicle power unit which is configured to include a motor which serves as a drive source, an input shaft which is coaxial with an output shaft of the motor and to which the power of the motor is input, a reduction gear pair, an output shaft to which the power of the motor is transmitted via the reduction gear pair with increased power from the input shaft, and a differential mechanism unit which differentially controls the power which is input from the output shaft and transmits the power to the drive wheels through a drive shaft.

JP 7-63253A (Reference 2) discloses a miniature electromotive vehicle in which a speed changer is provided in a power transmission path between a motor which serves as a drive source and drive wheels.

In recent years, there is also a demand for improved drivability and vehicle performance in a vehicle which uses an electric motor as a drive source. In a vehicle in which a general power transmission device which includes a reduction mechanism unit is installed as disclosed in Reference 1, increasing the physical size of the electric motor is unavoidable in order to improve the drivability, the vehicle performance, and the like and there are problems with the installation. Although it is valid to provide a speed changer between the motor and the drive wheels as disclosed in Reference 2, since the technique disclosed therein forcedly switches to a low-speed gear (a low gear) when there is high torque (an inclined state greater than or equal to a predetermined inclination), it takes time to perform the speed changing and there is a problem in the drivability.

Thus, a need exists for a vehicle power unit which is not susceptible to the drawback mentioned above.

### SUMMARY

A vehicle power unit according to an aspect of this disclosure includes an electric motor, an input shaft to which power of the electric motor is input, an intermediate shaft to which the power from the input shaft is transmitted, a drive shaft which is disposed parallel to the intermediate shaft, to which the power from the intermediate shaft is transmitted via a differential mechanism unit, and which transmits the power to drive wheels, a speed changer mechanism unit which is disposed on a power transmission path from the input shaft to the drive shaft and which includes two or more gear pairs, a switching unit which moves to freely engage and disengage with the gear pairs, and a one-way clutch, and a control unit which selects main control in which the control unit instructs the switching unit to cause the switching unit to be disposed at a neutral position in a case in which the power is transmitted via the one-way clutch and to cause the switching unit to be disposed at a position at which the switching unit engages with the gear pair that corresponds to a vehicle-requested gear in a case in which the power bypasses the one-way clutch and is transmitted, or selects auxiliary control in which the control unit instructs the switching unit to be forcedly disposed at a position at which the switching unit engages with the gear pair that corresponds to the vehicle-requested gear regardless of whether or not the power is transmitted via the one-way clutch.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram illustrating the basic configuration of a vehicle power unit according to an embodiment;

FIG. 2A is a schematic diagram illustrating a power transmission path in a case in which a vehicle-requested gear is a first speed gear and the vehicle is in a running state in the vehicle power unit according to the embodiment;

FIG. 2B is a schematic diagram illustrating a power transmission path in a case in which a vehicle-requested gear is a second speed gear in the vehicle power unit according to the embodiment;

FIG. 2C is a schematic diagram illustrating a power transmission path in a case in which a vehicle-requested gear is the first speed gear and the vehicle is in a regenerative state or in a case in which the vehicle-requested gear is a reverse gear in the vehicle power unit according to the embodiment;

FIG. 3A is a schematic block diagram of a general speed changing sequence during the speed changing;

FIG. 3B is a schematic block diagram of a speed changing sequence of a speed changer mechanism unit according to the embodiment during upward speed changing in the running state;

FIG. 3C is a schematic block diagram of a speed changing sequence of the speed changer mechanism unit according to the embodiment during the downward speed changing in the running state;

FIG. 4A is a diagram illustrating a speed changing sequence and a speed changing time chart of the speed changer mechanism unit according to the embodiment during the upward speed changing;

FIG. 4B is a diagram illustrating a speed changing sequence and a speed changing time chart in the related art during the upward speed changing;

FIG. 5A is a diagram illustrating a speed changing sequence and a speed changing time chart of the speed changer mechanism unit according to the embodiment during the downward speed changing;

FIG. 5B is a diagram illustrating a speed changing sequence and a speed changing time chart in the related art during the downward speed changing; and

FIG. 6 is a control process flowchart relating to main control and auxiliary control in the control unit.

### DETAILED DESCRIPTION

Hereinafter, a description will be given of various embodiments disclosed here with reference to the accompanying drawings. In the drawings, the same reference numerals are assigned to shared constituent elements. It should be noted that the constituent elements expressed in a certain drawing may be omitted in other drawings for convenience of explanation. Furthermore, it should be noted that the accompanying drawings are not necessarily drawn to an accurate scale.

### 1. Configuration of Vehicle Power Unit 1

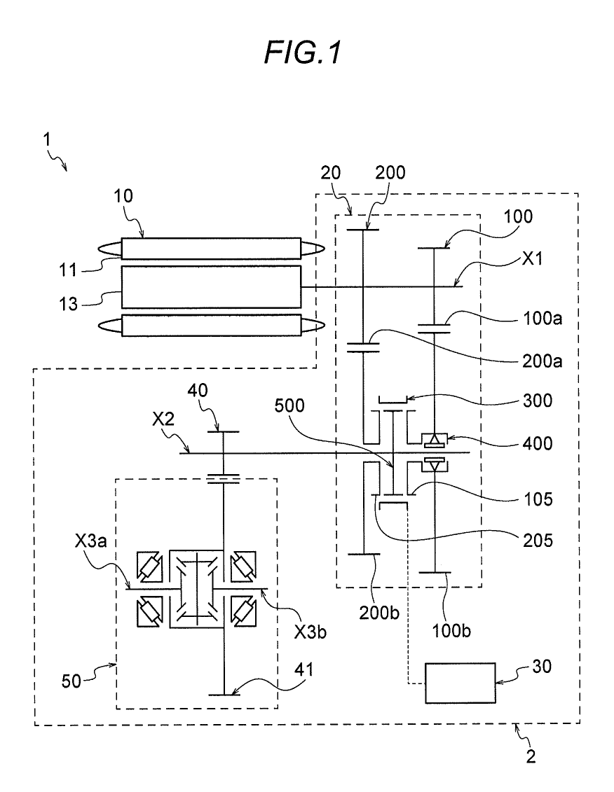

A description will be given of an outline of the overall configuration of the vehicle power unit 1 according to the embodiment with reference to FIG. 1. FIG. 1 is a schematic diagram illustrating the basic configuration of the vehicle power unit 1 according to the embodiment.

The vehicle power unit 1 according to the embodiment is configured to include a joint electric motor-and-generator 10 (hereinafter referred to as “an MG 10”) which serves as a drive source, and a trans-axle 2 which mainly includes a speed changer mechanism unit 20 and a differential mechanism unit 50. It is possible to use a general vehicle electric motor which is configured to include a stator 11 and a rotor 13 for the MG 10. The power which is generated by the rotor 13 in the MG 10 facing the stator 11 and rotating is transmitted to an input shaft X1 which is a power input unit of the trans-axle 2 in the vehicle power unit 1 and which rotates integrally with the rotor 13. The power which is input to the input shaft X1 is finally subjected to differential control by the differential mechanism unit 50 and is transmitted to drive wheels (not illustrated) via drive shafts X3a and X3b.

As illustrated in FIG. 1, the trans-axle 2 mainly includes the input shaft X1 which is described earlier, an intermediate shaft X2, the drive shafts X3a and X3b, the speed changer mechanism unit 20, a control unit 30, a final drive gear 40, and the differential mechanism unit 50 which includes a final driven gear 41. The intermediate shaft X2 is disposed parallel to the input shaft X1, the power from the input shaft X1 is transmitted to the intermediate shaft X2, the drive shafts X3a and X3b are disposed parallel to the intermediate shaft X2, the power from the intermediate shaft X2 is transmitted to the drive shafts X3a and X3b via the differential mechanism unit 50, the drive shafts X3a and X3b transmit the power to the drive wheels (not illustrated), the speed changer mechanism unit 20 is disposed on the input shaft X1 and the intermediate shaft X2, the control unit 30 instructs a switching unit 300 in the speed changer mechanism unit 20, the final drive gear 40 is disposed on the intermediate shaft X2, the final driven gear 41 is disposed on the drive shafts X3a and X3b and engages with the final drive gear 40, and the differential mechanism unit 50 connects to the drive shafts X3a and X3b. Hereinafter, a detailed description will be given of the constituent elements.

### 1-1. Input Shaft X1

As illustrated in FIG. 1, the input shaft X1 is provided to be capable of rotating integrally with the rotor 13 of the MG 10 and the power which is generated by the rotor 13 rotating inside the stator 11 is transmitted to the input shaft X1. A first speed drive gear 100a in a first speed gear pair 100 for low speed and a second speed drive gear 200a in a second speed gear pair 200 for high speed in the speed changer mechanism unit 20 (described in detail later) are provided to be capable of rotating integrally with the input shaft X1, and thus, the speed changer mechanism unit 20 is configured to be capable of transmitting the power which is input to the input shaft X1 from the MG 10 to both the first speed drive gear 100a and the second speed drive gear 200a (as described later, the power is transmitted to only one of the first speed drive gear 100a and the second speed drive gear 200a by the speed changer mechanism unit 20 and the other simply idles). Both ends of the input shaft X1 are axially supported by bearings (not illustrated) which are fixed to housings (not illustrated), for example.

### 1-2. Intermediate Shaft X2

As illustrated in FIG. 1, the intermediate shaft X2 is disposed parallel to the input shaft X1. The switching unit 300 and a hub unit 500 which is always engaged with the switching unit 300 in the speed changer mechanism unit 20 (described later in detail) are provided to be capable of rotating integrally with the intermediate shaft X2. A first speed driven gear 100b in the first speed gear pair 100 and a second speed driven gear 200b in the second speed gear pair 200 are provided on the intermediate shaft X2 to be capable of rotating relative to the intermediate shaft X2. However, as described later, when the switching unit 300 is disposed at a position at which the switching unit 300 engages with one of the first speed driven gear 100b and the second speed driven gear 200b (one of the first speed gear pair 100 and the second speed gear pair 200), the power which is input to the input shaft X1 is transmitted to the intermediate shaft X2. In more detail, for example, in a case in which the switching unit 300 engages with the second speed driven gear 200b (the second speed gear pair 200), the power which is input to the input shaft X1 is transmitted to the intermediate shaft X2 via the second speed drive gear 200a and the second speed driven gear 200b of the second speed gear pair 200, the switching unit 300, and the hub unit 500. The final drive gear 40 which rotates integrally with the intermediate shaft X2 is provided on the intermediate shaft X2. Both ends of the intermediate shaft X2 are axially supported by bearings (not illustrated) which are fixed to housings (not illustrated), for example, in the same manner as in the input shaft X1.

### 1-3. Drive Shafts X3a and X3b

As illustrated in FIG. 1, the drive shafts X3a and X3b are disposed parallel to the intermediate shaft X2. A drive wheel (not illustrated) is provided on each of the end portions of the drive shafts X3a and X3b and the power which is generated by the MG 10 is finally transmitted to the drive wheels. The drive shafts X3a and X3b are connected to the differential mechanism unit 50 (described later). When the power is transmitted from the intermediate shaft X2 to the differential mechanism unit 50 via the final driven gear 41 which is always engaged with the final drive gear 40 (previously described), the power is subjected to differential control by the differential mechanism unit 50 according to the driving situation (forward progression, left or right turning, or the like) and is transmitted to the drive shafts X3a and X3b to be finally transmitted to the drive wheels. The drive shafts X3a and X3b are also axially supported by the bearing.

### 1-4. Speed Changer Mechanism Unit 20

As illustrated in FIG. 1, speed changer mechanism unit 20 is disposed on the power transmission path from the input shaft X1 to the drive shafts X3a and X3b. More specifically, the speed changer mechanism unit 20 is configured to include the first speed gear pair 100, the second speed gear pair 200, the switching unit 300, and a one-way clutch 400. Of these, the first speed drive gear 100a in the first speed gear pair 100 and the second speed drive gear 200a in the second speed gear pair 200 are provided to be capable of rotating integrally with the input shaft X1 and the first speed driven gear 100b in the first speed gear pair 100 and the second speed driven gear 200b in the second speed gear pair 200 are provided on the intermediate shaft X2 to be capable of rotating relative to the intermediate shaft X2. Meanwhile, the switching unit 300 is always engaged with the hub unit 500 and is provided to be capable of rotating integrally with the intermediate shaft X2. The one-way clutch 400 is provided on the intermediate shaft X2 and is disposed to be clamped between the intermediate shaft X2 and the first speed driven gear 100b in the first speed gear pair 100.

### 1-4-1. Gear Pairs (First Speed Gear Pair 100 and Second Speed Gear Pair 200)

As illustrated in FIG. 1, although the two gear pairs, the first speed gear pair 100 and the second speed gear pair 200, are provided in the speed changer mechanism unit 20, a third speed gear may be further added to provide three gear pairs. However, when the number of gear pairs increases to handle multi-stage speed changing such as fifth gear and sixth gear (for example, greater than or equal to five gear pairs), since the physical size of the speed changer mechanism unit 20 increases, this is unfavorable. The speed changing ratios of each of the first speed gear pair 100 and the second speed gear pair 200 may be set as appropriate, and are not particularly limited. In FIG. 1, although the second speed gear pair 200 is provided on the top-left side of the first speed gear pair 100 on the paper surface, the second speed gear pair 200 may be provided on the top-right side of the first speed gear pair 100 on the paper surface.

As illustrated in FIG. 1, a first dog portion 105 and a second dog portion 205 are provided on the first speed driven gear 100b and the second speed driven gear 200b, respectively. Accordingly, the switching unit 300 is capable of engaging with the first speed driven gear 100b or the second speed driven gear 200b by moving on the intermediate shaft X2 in an axial direction based on the instructions of the control unit 30.

### 1-4-2. Switching Unit 300

As described earlier, the switching unit 300 is always engaged with the hub unit 500 and is provided to be capable of rotating integrally with the intermediate shaft X2. More specifically, for example, the switching unit 300 may include a sleeve portion (not illustrated) and an actuator portion (not illustrated), and a configuration may be adopted in which the actuator portion detects an instruction from the control unit 30 and actuates the sleeve portion based on the instruction. It is possible to use a general solenoid actuator portion for the actuator portion, for example. The sleeve portion is configured to be capable of moving to freely engage and disengage with the first dog portion 105 and the second dog portion 205 in the axial direction on the intermediate shaft X2. When the actuator portion detects the instruction of the control unit 30, the actuator portion causes the sleeve portion to move to one of a position at which the sleeve portion engages with the first dog portion 105, a position at which the sleeve portion engages with the second dog portion 205, and a neutral position at which the sleeve portion does not engage with either of the first dog portion 105 and the second dog portion 205 based on the instruction.

Accordingly, in a case in which the sleeve portion is disposed at a position at which the sleeve portion engages with the first dog portion 105 (engages with the first speed gear pair 100), for example, the power which is input to the input shaft X1 is transmitted to the intermediate shaft X2 via the first speed drive gear 100a and the first speed driven gear 100b of the first speed gear pair 100, the switching unit 300 (the sleeve portion), and the hub unit 500.

### 1-4-3. One-Way Clutch 400

As described earlier, the one-way clutch 400 is provided on the intermediate shaft X2 and is disposed to be clamped between the intermediate shaft X2 and the first speed driven gear 100b in the first speed gear pair 100 in a direction perpendicular to the axial direction. It is possible to use a one-way clutch having a well-known structure for the one-way clutch 400 as long as the one-way clutch which is used transmits power in only one direction and idles in the reverse direction. In other words, the one-way clutch 400 illustrated in FIG. 1 controls the transmission or non-transmission of the power from the first speed driven gear 100b to the intermediate shaft X2 according to the rotation speed difference between the first speed driven gear 100b which is on the input side and the intermediate shaft X2 which is on the output side. For example, in a case in which the rotation speed of the first speed driven gear 100b is greater than or equal to the rotation speed of the intermediate shaft X2, the one-way clutch 400 transmits the power from the first speed driven gear 100b to the intermediate shaft X2. Conversely, in a case in which the rotation speed of the first speed driven gear 100b is less than the rotation speed of the intermediate shaft X2, the one-way clutch 400 idles and does not transmit the power from the first speed driven gear 100b to the intermediate shaft X2.

Due to these characteristics, it is preferable that the one-way clutch 400 be provided on the first speed gear pair 100 side (on the first speed driven gear 100b side as illustrated in FIG. 1 or on the first speed drive gear 100a as described later). Hypothetically, if the one-way clutch 400 is provided on the second speed gear pair 200 side (for example, on the second speed driven gear 200b side), since the one-way clutch 400 effectively assumes a state of always transmitting power, since the likelihood of double gear meshing occurring increases, this is unfavorable.

### 1-5. Control Unit 30

The control unit 30 receives various information which is obtained using a rotation speed sensor (for example, a resolver) and a positional sensor (a stroke sensor) which are provided separately through CAN communication or the like and instructs the actuator portion in the switching unit 300 in order to dispose the switching unit 300 (the sleeve portion) at an appropriate position according to the situation of the vehicle. A detailed description will be given later of the main control and the auxiliary control in the control unit 30.

### 1-6. Differential Mechanism Unit 50

As illustrated in FIG. 1, when power is transmitted to the final driven gear 41 which engages with the final drive gear 40, the power is transmitted to a differential gear (not illustrated) inside the differential mechanism unit 50 and is subjected to differential control (for example, the difference in rotation of the left and right wheels is controlled) in the differential gear according to the driving situation (forward progression, left or right turning, or the like). The drive shafts X3a and X3b are connected to the differential gear, the power is distributed to the drive shafts X3a and X3b based on the differential control which is described earlier, and the power which is distributed is finally transmitted to each of the drive wheels (not illustrated).

Hereinabove, although a detailed description is given of the constituent elements of the speed changer mechanism unit 20, the disposition of each of the constituent elements in the speed changer mechanism unit 20 is not limited to the embodiment and various configurations may be adopted. For example, a configuration may be adopted in which the input shaft X1 has a hollow shape and the drive shafts X3a and X3b are inserted through the inner portion of the input shaft X1. The switching unit 300 and the one-way clutch 400 may be provided on the input shaft X1 instead of on the intermediate shaft X2 which is described earlier, and the sleeve portion of the switching unit 300 may be disposed to be capable of moving in the axial direction of the input shaft X1. In this case, the first dog portion 105 is provided on the first speed drive gear 100a and the second dog portion 205 (described earlier) is provided on the second speed drive gear 200a.

2. Operation of Speed Changer Mechanism Unit 20 in Vehicle Power Unit 1

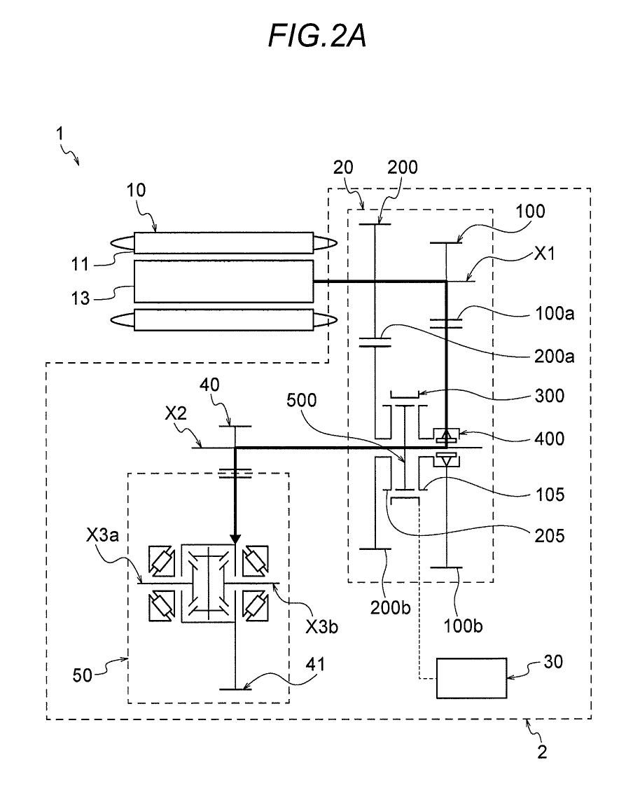

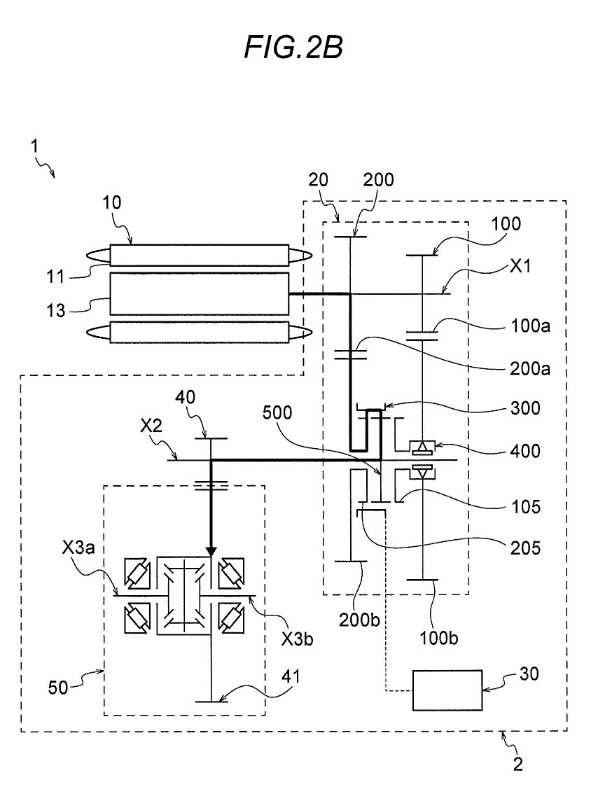

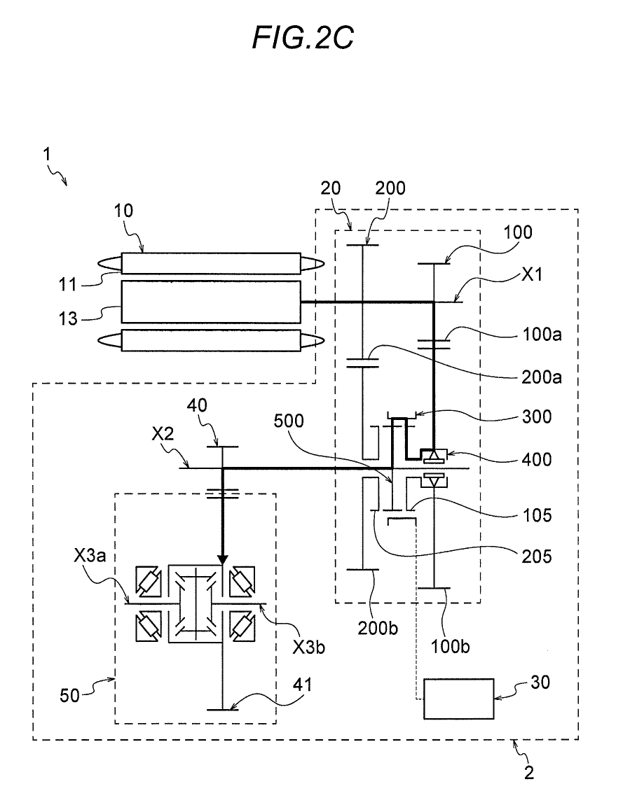

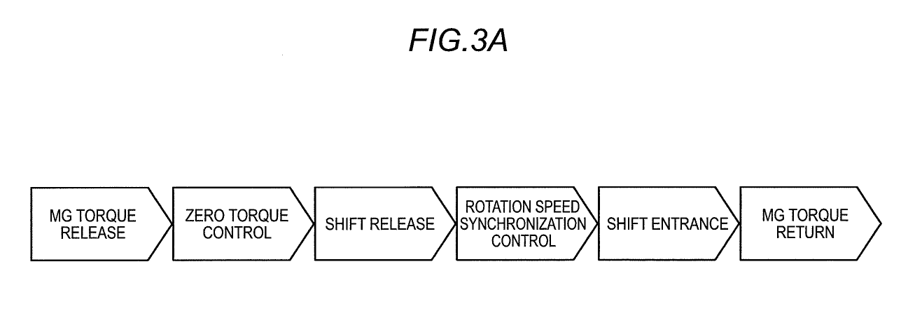

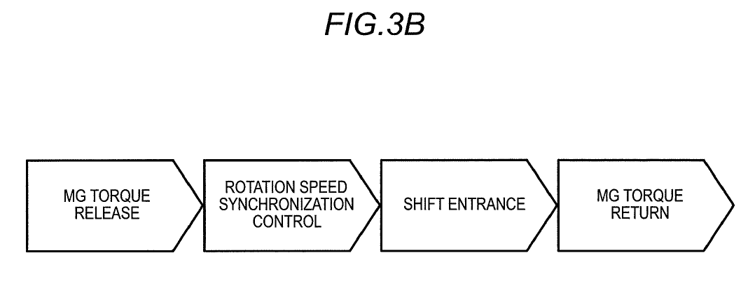

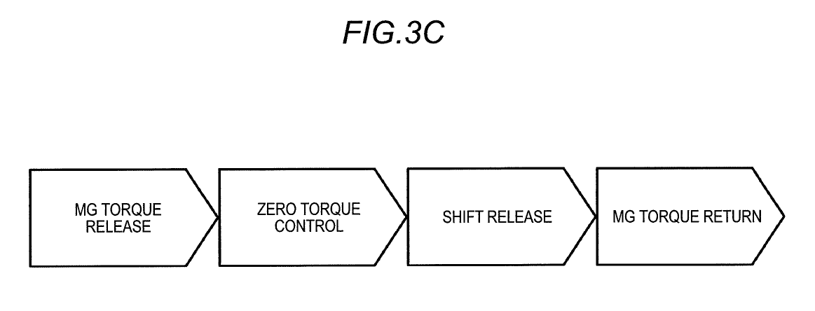

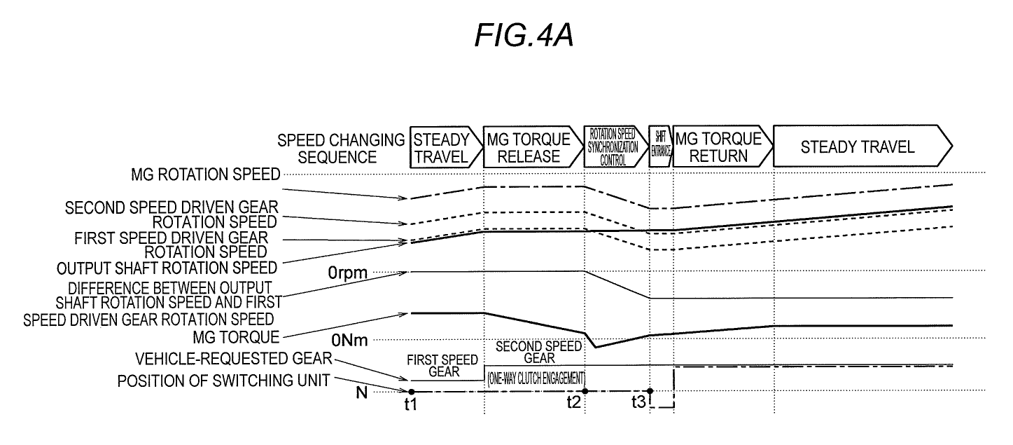

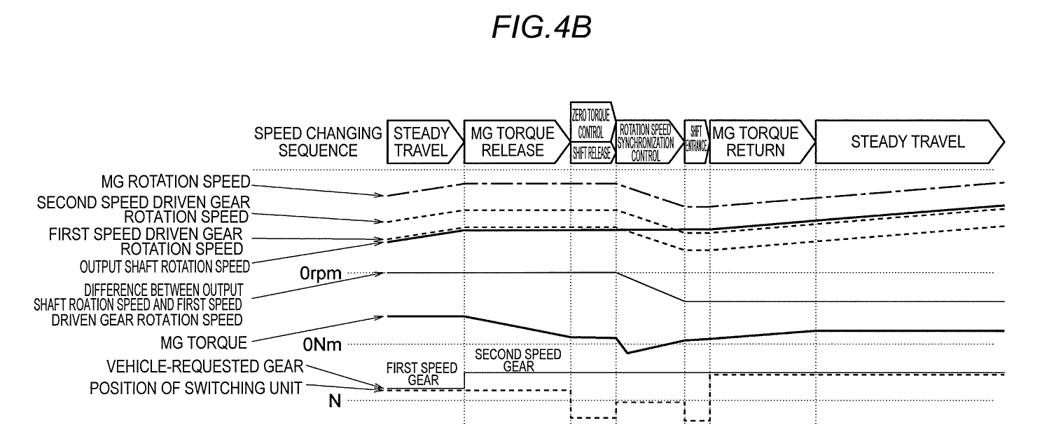

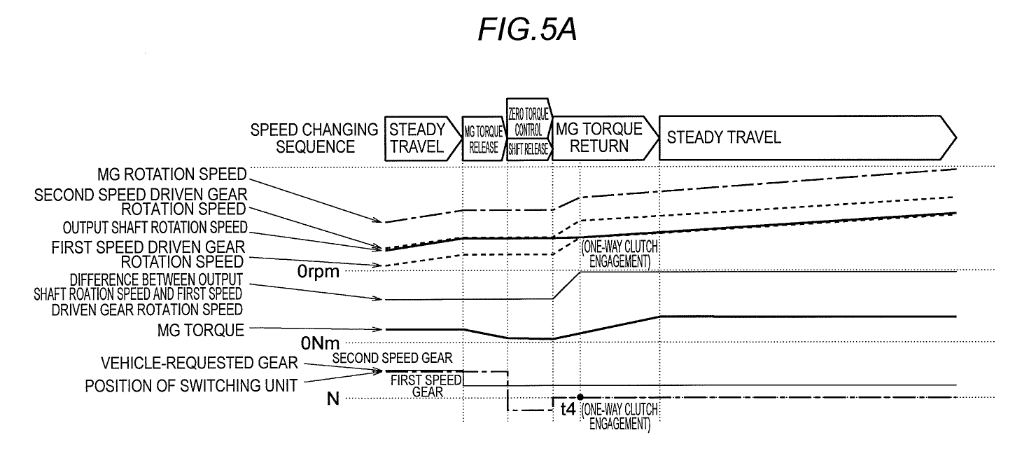

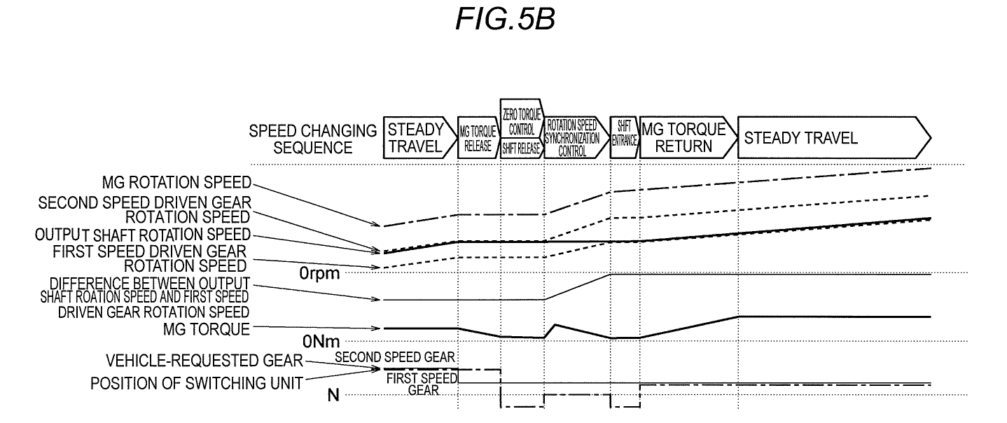

Next, a description will be given of the operation of the speed changer mechanism unit 20 in the vehicle power unit 1 which has the configuration described above with reference to FIGS. 2A to 5B. FIG. 2A is a schematic diagram illustrating a power transmission path in a case in which a vehicle-requested gear is a first speed gear and the vehicle is in a running state in the vehicle power unit 1 according to the embodiment. FIG. 2B is a schematic diagram illustrating a power transmission path in a case in which a vehicle-requested gear is a second speed gear in the vehicle power unit 1 according to the embodiment. FIG. 2C is a schematic diagram illustrating a power transmission path in a case in which a vehicle-requested gear is the first speed gear and the vehicle is in a regenerative state or in a case in which the vehicle-requested gear is a reverse gear in the vehicle power unit 1 according to the embodiment. FIG. 3A is a schematic block diagram of a speed changing sequence of the related art during the speed changing. FIG. 3B is a schematic block diagram of a speed changing sequence of the speed changer mechanism unit 20 according to the embodiment during upward speed changing in the running state. FIG. 3C is a schematic block diagram of a speed changing sequence of the speed changer mechanism unit 20 according to the embodiment during the downward speed changing in the running state. FIG. 4A is a diagram illustrating a speed changing sequence and a speed changing time chart of the speed changer mechanism unit 20 according to the embodiment during the upward speed changing. FIG. 4B is a diagram illustrating a speed changing sequence and a speed changing time chart in the related art during the upward speed changing. FIG. 5A is a diagram illustrating a speed changing sequence and a speed changing time chart of the speed changer mechanism unit according to the embodiment during the downward speed changing. FIG. 5B is a diagram illustrating a speed changing sequence and a speed changing time chart in the related art during the downward speed changing.

Since the one-way clutch 400 is provided in the speed changer mechanism unit 20 in the embodiment as described earlier, as a basic principle, in a case in which the power is transmitted from the input shaft X1 to the intermediate shaft X2 via at least the one-way clutch 400 and is finally transmitted to the drive wheels, from the perspective of preventing double gear meshing, the control unit 30 instructs the actuator portion to cause the sleeve portion in the switching unit 300 to be disposed at the neutral position. Conversely, in a case in which the one-way clutch 400 is idle and does not transmit the power (in a case in which the power bypasses the one-way clutch 400 and is transmitted), the control unit 30 instructs the actuator portion to cause the sleeve portion in the switching unit 300 to be disposed at a position at which the sleeve portion engages with a gear pair corresponding to the vehicle-requested gear (the first speed gear, the second speed gear, or the reverse gear). Naturally, in a case in which the vehicle-requested gear is neutral, the control unit 30 instructs the actuator portion to cause the sleeve portion in the switching unit 300 to be disposed at the neutral position.

Hereinafter, a detailed description will be given of the operation of the speed changer mechanism unit 20 according to the various traveling situations based on the basic principle which is described above.

As illustrated in FIG. 2A, in a case in which the vehicle-requested gear is the first speed gear and the vehicle is in the running state, since the first speed driven gear 100b and the intermediate shaft X2 assume the same rotation speed, the power which is input to the input shaft X1 is transmitted to the intermediate shaft X2 via the one-way clutch 400. In this case, the sleeve portion of the switching unit 300 is disposed at the neutral position without engaging with the first speed driven gear 100b (and without engaging with the second speed driven gear 200b) based on the basic principle which is described earlier. In other words, even if the vehicle-requested gear and the actual position of the sleeve portion of the switching unit 300 are different, it is possible for the vehicle to handle the vehicle-requested gear. In this manner, in a case in which the vehicle-requested gear is the first speed gear and the vehicle is in the running state, since it is possible to shorten the movement time of the sleeve portion of the switching unit 300 (omitting the so-called shift release time) in a case in which the upward speed changing is performed while still in the running state as described later by disposing the sleeve portion of the switching unit 300 at the neutral position, it is possible to shorten the speed changing time and the drivability of the vehicle is improved.

For example, the vehicle-requested gear means the gear that is requested by the vehicle (for example, the gear instructed by a transmission ECU) in the vehicle which is automatically subjected to speed changing control according to the gearstick position in the driver seat, the speed changing ratio of the first speed gear pair 100 and the second speed gear pair 200, the traveling state of the vehicle, and the like.

Next, as illustrated in FIG. 2B, in a case in which the vehicle-requested gear is the second speed gear, the sleeve portion of the switching unit 300 is disposed at a position at which the sleeve portion engages with the second speed driven gear 200b and the power which is input to the input shaft X1 is transmitted to the intermediate shaft X2 via the second speed gear pair 200. In this case, since the rotation speed of the first speed driven gear 100b is less than the rotation speed of the intermediate shaft X2, the one-way clutch 400 idles and double gear meshing does not occur.

Next, as illustrated in FIG. 2C, in a case in which the vehicle-requested gear is the first speed gear and the vehicle is in the regenerative state or in a case in which the vehicle-requested gear is the reverse gear, since the rotation speed of the first speed driven gear 100b is less than the rotation speed of the intermediate shaft X2, the one-way clutch 400 idles. Therefore, the sleeve portion of the switching unit 300 is disposed at a position at which the sleeve portion engages the first speed driven gear 100b. In other words, in a case in which the vehicle-requested gear is the first speed gear, every time the vehicle switches between the running state and the regenerative state, the sleeve portion of the switching unit 300 also moves reciprocally between the neutral position and a position at which the sleeve portion engages with the first speed driven gear 100b (moves reciprocally between the state of FIG. 2A and the state of FIG. 2C). A detailed description will be given later of the auxiliary control which solves the problem of a case in which this reciprocal movement occurs excessively.

Next, a description will be given of the speed changing sequence of the speed changer mechanism unit 20 in a case in which the upward speed changing or the downward speed changing is performed.

As illustrated in FIG. 3A, a general speed changing sequence during the speed changing in the vehicle power unit (not including a one-way clutch) which includes the MG 10 is configured to mainly include a first step to a sixth step. The power transmission which is generated by the MG 10 is attenuated in the first step (MG torque release), the power is finally not transmitted in the second step (zero torque control), the sleeve portion which is engaged with the gear pair of the previous speed changing is moved to the neutral position in the third step (shift release), the rotation speed of the output shaft and the rotation speed of the gear pair after the speed changing are synchronized in the fourth step (rotation speed synchronization control), the sleeve portion of the neutral position is moved to a position at which the sleeve portion engages with the gear pair after the speed changing in the fifth step (shift entrance), and the transmission of the power which is generated by the MG 10 is returned to the output shaft in the sixth step (MG torque return). Since each step is a step which is generally carried out in the related art, the detailed description thereof will be omitted.

On the other hand, as illustrated in FIG. 3B, in a case in which the vehicle-requested gear is the first speed gear and the vehicle is in the running state, in a case in which an instruction of upward speed changing the vehicle-requested gear from the first speed gear to the second speed gear is performed, as compared to the general speed changing sequence illustrated in FIG. 3A, since the speed changing sequence of the speed changer mechanism unit 20 according to the embodiment does not include the second step (zero torque control) and the third step (shift release), it is possible to shorten the speed changing time by an amount of time corresponding to the second step and the third step, and the drivability of the vehicle is improved. As described earlier, in a case in which the vehicle-requested gear is the first speed gear and the vehicle is in the running state, since the sleeve portion of the switching unit 300 is disposed at the neutral position in advance, caused by it being possible to transmit the power via the one-way clutch 400, the zero torque control and the shift release are not necessary to begin with, and it is possible to move the sleeve portion to a position at which the sleeve portion engages with the second speed gear pair 200 (the second speed driven gear 200b) based on the instruction of the control unit 30.

A detailed description will be given of the speed changing sequence during the upward speed changing illustrated in FIG. 3B while comparatively referencing FIG. 4A which depicts a speed changing time chart and FIG. 4B which illustrates a general speed changing sequence in a vehicle power unit which includes the MG 10.

As illustrated in FIG. 4A, in a case in which the vehicle-requested gear is the first speed gear and the vehicle is traveling steadily (a running state in which the MG torque is greater than or equal to 0 Nm), since the first speed driven gear 100b and the output shaft (the intermediate shaft X2 in the embodiment) assume the same rotation speed, the power which is input to the input shaft X1 is transmitted to the intermediate shaft X2 via the one-way clutch 400 (the one-way clutch 400 engages the intermediate shaft X2). In this case, the sleeve portion of the switching unit 300 is disposed at the neutral position. On the other hand, in a general speed changing sequence, in a case in which the vehicle-requested gear is the first speed gear, naturally, the sleeve portion of the switching unit 300 is disposed at a position at which the sleeve portion engages the first speed driven gear 100b.

Next, when the vehicle-requested gear is an instruction of upward speed changing from the first speed gear to the second speed gear, in comparison to FIG. 4B, in FIG. 4A, it is possible to move the sleeve portion of the switching unit 300 to a position at which the sleeve portion engages with the second speed driven gear 200b at the time (the t3 time in FIG. 4A) at which the second speed driven gear 200b is synchronized (subjected to rotation speed synchronization control) to the rotation speed of the intermediate shaft X2 without undergoing zero torque control and shift release. The upward speed changing is completed by returning the MG torque at the timing at which the movement of the sleeve portion is completed. As illustrated in FIG. 4A, the one-way clutch 400 engages with the intermediate shaft X2 in the time between the t1 time at which the vehicle-requested gear is the first speed gear and the vehicle is traveling steadily and a starting time (the t2 time) of the rotation speed synchronization control. From the t2 time onward, since the rotation speed of the first speed driven gear 100b is less than the rotation speed of the intermediate shaft X2, the one-way clutch 400 always idles without transmitting power.

Next, a description will be given of a case of downward speed changing time in the same manner. As illustrated in FIG. 3C, in a case in which an instruction is performed in which the vehicle-requested gear is downward speed changing from the second speed gear to the first speed gear in the running state, in comparison to the general speed changing sequence illustrated in FIG. 3A, since the speed changing sequence of the speed changer mechanism unit 20 according to the embodiment does not include the fourth step (the rotation speed synchronization control) and the fifth step (the shift entrance), it is possible to shorten the speed changing time by an amount of time corresponding to the fourth step and the fifth step, and the drivability of the vehicle is improved. This originates in the fact that, since it is possible to transmit the power to the output shaft via the first speed driven gear 100b and the one-way clutch 400 at effectively the same time as the MG torque return step (the sixth step) in a case in which the downward speed changing from the second speed gear to the first speed gear is performed in the running state, it is not necessary to cause the sleeve portion of the switching unit 300 to engage (the sleeve portion does not engage) with the first speed gear pair 100 (the first speed driven gear 100b). Therefore, in a case of the downward speed changing time, the sleeve portion of the switching unit 300 moves from the position at which the sleeve portion engages with the second speed gear pair 200 (the second speed driven gear 200b) to the neutral position based on an instruction of the control unit.

A detailed description will be given of the speed changing sequence during the downward speed changing illustrated in FIG. 3C while comparatively referencing FIG. 5A which depicts a speed changing time chart and FIG. 5B which illustrates a general speed changing sequence in a vehicle power unit which includes the MG 10.

As illustrated in FIG. 5A, in a case in which the vehicle-requested gear is the second speed gear and the vehicle is traveling steadily (a running state in which the MG torque is greater than or equal to 0 Nm), since the rotation speed of the first speed driven gear 100b is less than the rotation speed of the intermediate shaft X2, the one-way clutch 400 idles and the power which is input to the input shaft X1 is transmitted to the intermediate shaft X2 via the second speed gear pair 200. In this case, the sleeve portion of the switching unit 300 is disposed at a position at which the sleeve portion engages with the second speed driven gear 200b. Even in a general speed changing sequence, in the same manner, in a case in which the vehicle-requested gear is the second speed gear, naturally, the sleeve portion of the switching unit 300 is disposed at a position at which the sleeve portion engages with the second speed driven gear 200b.

Next, when the vehicle-requested gear is an instruction of downward speed changing from the second speed gear to the first speed gear, in comparison to FIG. 5B, in FIG. 5A, it is possible to complete the downward speed changing merely by the MG torque returning without undergoing the rotation speed synchronization control and the shift entrance. In other words, if the sleeve portion of the switching unit 300 is moved from the position at which the sleeve portion engages with the second speed driven gear 200b to the neutral position, power transmission becomes possible via the one-way clutch 400 due to the one-way clutch 400 engaging with the intermediate shaft X2 at the time (the t4 time in FIG. 5A) at which the rotation speed of the first speed driven gear 100b and the rotation speed of the intermediate shaft X2 become the same merely by causing the MG torque to return. From the t4 time onward, as long as the running state continues, the one-way clutch 400 is always engaged with the intermediate shaft X2.

### 3. Main Control and Auxiliary Control in Control Unit 30

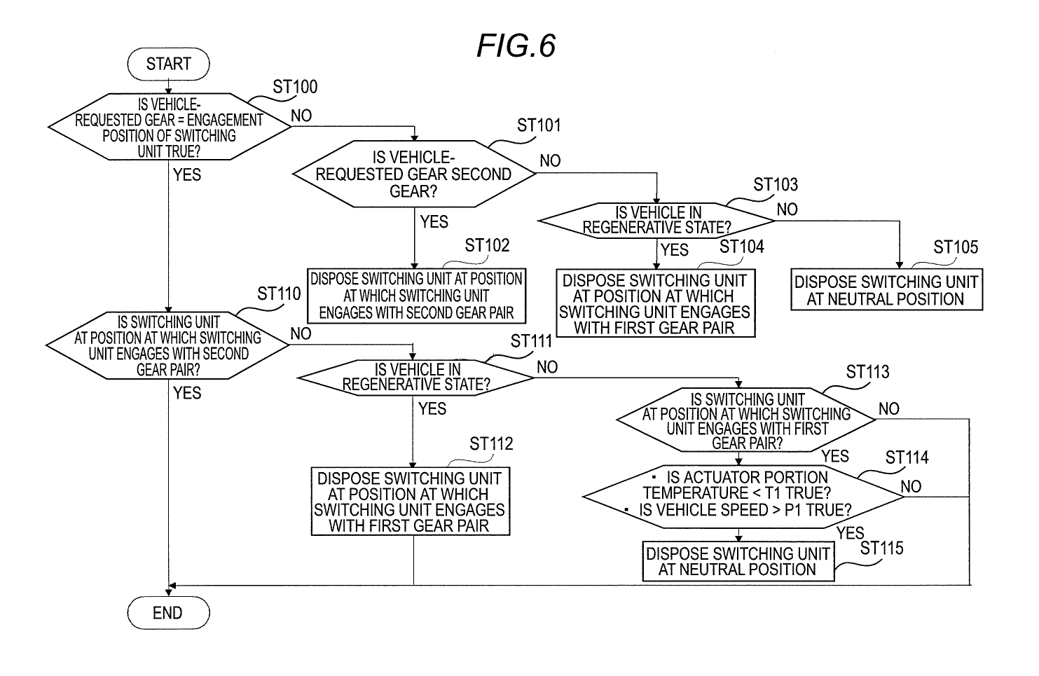

Next, a detailed description will be given of the main control and the auxiliary control in the control unit 30 with reference to FIG. 6. FIG. 6 is a control process flowchart relating to the main control and the auxiliary control in the control unit 30.

As described earlier, the control unit 30 ascertains various driving information and the traveling information of the vehicle by receiving various information through CAN communication or the like from a rotation speed sensor (for example, a resolver) which detects the rotation speed of the MG 10, a positional sensor (for example, a stroke sensor) which detects the position of the switching unit 300 (the sleeve portion or the actuator portion), various sensors (for example, gear position sensors) which detect the vehicle-requested gear, a pedal sensor which detects the opening degrees of the accelerator pedal and the brake pedal, and the like. Once the control unit 30 ascertains the various driving information and the traveling information of the vehicle and outputs an instruction as to which position at which to dispose the sleeve portion after carrying out the control processes relating to the main control and the auxiliary control illustrated in FIG. 6.

As illustrated in FIG. 6, first, the control unit 30 checks whether the vehicle-requested gear and the position at which the switching unit 300 (the sleeve portion) is engaged match in step ST100 (ST100 in FIG. 6). Here, during the upward speed changing (in a case in which the vehicle-requested gear is the second speed gear whereas the sleeve portion is at a position at which the sleeve portion engages with the first speed gear pair 100 or the sleeve portion is at the neutral position as described earlier) or during the downward speed changing (in a case in which the vehicle-requested gear is the first speed gear, whereas the sleeve portion is at the position at which the sleeve portion engages with the second speed gear pair 200) which are described earlier, since neither matches, the control unit 30 proceeds to step ST101 (ST101 in FIG. 6) onward.

In step ST101, first, the control unit 30 checks whether upward speed changing or downward speed changing is underway. For example, if the vehicle-requested gear is the second speed gear, the sleeve portion is disposed at a position at which the sleeve portion engages with the first speed gear pair 100 or is disposed at the neutral position. Therefore, upon determining that the upward speed changing is underway, the control unit 30 performs an instruction to cause the sleeve portion to be disposed at (moved to) a position at which the sleeve portion engages with the second speed gear pair 200 in step ST102 (ST102 in FIG. 6). At this time, in a case in which the sleeve portion moves from the neutral position to the position at which the sleeve portion engages with the second speed gear pair 200, as described earlier, it is possible to shorten the speed changing time.

Conversely, for example, if the vehicle-requested gear is the first speed gear, the sleeve portion is disposed at a position at which the sleeve portion engages with the second speed gear pair 200. Therefore, upon determining that the downward speed changing is underway, the control unit 30 further determines whether or not the vehicle is in the regenerative state in step ST103 (ST103 in FIG. 6). In the present specification, the regenerative state refers to a state in which the accelerator pedal is not being depressed or a state in which the brake pedal is being depressed, and a state in which the accelerator pedal is being depressed is determined to be the running state (however, during so-called creeping, a state in which the accelerator pedal is not being depressed may be determined to be the running state). A configuration may be adopted in which a state in which the MG 10 outputs power in the forward direction is determined to be the running state and a state in which the MG 10 outputs power in the reverse direction is determined to be the regenerative state.

In step ST103, when the control unit 30 determined that the vehicle is in the regenerative state, the control unit 30 performs an instruction to cause the sleeve portion to be disposed at (moved to) a position at which the sleeve portion engages with the first speed gear pair 100 in step ST104 (ST104 in FIG. 6). On the other hand, when the control unit 30 determines that the vehicle is in the running state instead of the regenerative state, the control unit 30 performs an instruction to cause the sleeve portion to be disposed at (moved to) the neutral position in step ST105 (ST105 in FIG. 6). In this manner, in a case in which the vehicle is in the running state, since it is not necessary to move the sleeve portion to a position at which the sleeve portion engages with the first speed gear pair 100, as described earlier, it is possible to shorten the speed changing time.

Next, in step ST100, in a case in which both match (for example, in a case in which the vehicle-requested gear is the second speed gear and the sleeve portion is disposed at a position at which the sleeve portion engages with the second speed gear pair 200), the control unit 30 proceeds to step ST110 (ST110 in FIG. 6) onward. First, in a case in which the sleeve portion is disposed at a position at which the sleeve portion engages with the second speed gear pair 200, the control process of the control unit 30 ends.

On the other hand, in a case in which the sleeve portion is disposed at a position at which the sleeve portion does not engage with the second speed gear pair 200, that is, in a case in which the sleeve portion is disposed at a position at which the sleeve portion engages with the first speed gear pair 100, the control unit 30 proceeds to step ST111 (ST111 in FIG. 6) onward. In step ST111, the control unit 30 determines whether or not the vehicle is in the regenerative state. Since the vehicle-requested gear is the first speed gear as a premise of step ST111, as described earlier, when the control unit 30 determines that the vehicle is in the regenerative state, the sleeve portion is left as it is, disposed at a position at which the sleeve portion engages with the first speed gear pair 100 in step S112 (ST112 in FIG. 6). Conversely, when the control unit 30 determines that the vehicle is in the running state instead of the regenerative state, upon re-checking whether the sleeve portion is disposed at a position at which the sleeve portion engages with the first speed gear pair 100 in step ST113 (ST113 in FIG. 6), if the predetermined conditions in step ST114 (ST114 in FIG. 6) are satisfied, the control unit 30 disposes the sleeve portion at (moves the sleeve portion to) the neutral position in step ST115. In this case, since the vehicle-requested gear is the first speed gear and the vehicle is in the running state, as described earlier, the power which is generated by the MG 10 is transmitted to the drive wheels via the one-way clutch 400.

Here, the predetermined conditions in step ST114 determine, for example, whether or not the temperature of the actuator portion is less than or equal to a predetermined temperature (T1) set in advance or whether or not the vehicle speed is greater than or equal to a predetermined speed (P1). In step ST114, the conditions of the temperature of the actuator portion and the vehicle speed may be determined as an AND condition. For the measurement of the temperature of the actuator portion, a temperature sensor may be disposed on the actuator portion, or an estimation unit which integrates values of the current which flows in the actuator portion per unit time to estimate the temperature of the actuator portion may be disposed.

For example, during traffic congestion or the like, when the running state and the regenerative state are repeated in a case in which the vehicle-requested gear is the first speed gear, the sleeve portion excessively reciprocates between the neutral position and the position at which the sleeve portion engages with the first speed gear pair 100, excessive electrical power consumption occurs, and as a result, this may lead to a worsening in fuel efficiency. In a case in which the actuator portion uses a solenoid system or a DC motor system, a problem in that the actuator portion becomes high temperature may occur. Therefore, it is possible to prevent the occurrence of such a problem by adding a determination step of step ST114. In other words, in step ST114, in a case in which the temperature of the actuator portion is greater than or equal to a predetermined temperature (T1) or in a case in which the vehicle speed is less than or equal to a predetermined speed (P1), even if the vehicle is hypothetically in the running state, the sleeve portion is disposed at a position at which the sleeve portion engages with the first speed gear pair 100 and the movement of the sleeve portion to the neutral position is restricted (the sleeve portion is forcedly disposed at a position at which the sleeve portion engages with the gear pair corresponding to the vehicle-requested gear regardless of whether or not the power is transmitted via the one-way clutch 400). Accordingly, by efficiently using a bypass path which transmits the power using the one-way clutch 400 (by using the bypass path during the upward speed changing or during the downward speed changing), it is possible to prevent a worsening in fuel efficiency while obtaining an improvement in the drivability based on a shortening of the speed changing time. Step ST114 corresponds to the auxiliary control and the other control processes correspond to the main control.

A vehicle power unit according to an aspect of this disclosure includes an electric motor, an input shaft to which power of the electric motor is input, an intermediate shaft to which the power from the input shaft is transmitted, a drive shaft which is disposed parallel to the intermediate shaft, to which the power from the intermediate shaft is transmitted via a differential mechanism unit, and which transmits the power to drive wheels, a speed changer mechanism unit which is disposed on a power transmission path from the input shaft to the drive shaft and which includes two or more gear pairs, a switching unit which moves to freely engage and disengage with the gear pairs, and a one-way clutch, and a control unit which selects main control in which the control unit instructs the switching unit to cause the switching unit to be disposed at a neutral position in a case in which the power is transmitted via the one-way clutch and to cause the switching unit to be disposed at a position at which the switching unit engages with the gear pair that corresponds to a vehicle-requested gear in a case in which the power bypasses the one-way clutch and is transmitted, or selects auxiliary control in which the control unit instructs the switching unit to be forcedly disposed at a position at which the switching unit engages with the gear pair that corresponds to the vehicle-requested gear regardless of whether or not the power is transmitted via the one-way clutch.

With this configuration, it is possible to improve the vehicle performance without increasing the physical size of the electric motor by providing the speed changer mechanism unit and it is possible to provide the vehicle power unit which is compact overall. Since the speed changer mechanism unit includes the one-way clutch, it is possible to form two paths, a general path which goes via one of the gear pairs, and a bypass path which goes via the one-way clutch as power transmission paths in the vehicle power unit. Accordingly, in a case in which the speed changing is performed in a state in which the power is transmitted via the one-way clutch, since it is possible to omit ordinary operations such as shift release, shift entrance, or the like, it is possible to shorten the speed changing time. As a result, it is possible to improve the drivability in the vehicle power unit.

Furthermore, by appropriately selecting the main control and the auxiliary control, the control unit is capable of preventing a worsening in fuel efficiency, which originates in unnecessary electrical power consumption, while shortening the speed changing time.

In the vehicle power unit according to the aspect of this disclosure, it is preferable that the gear pairs include a first speed gear pair and a second speed gear pair, and that the one-way clutch is provided on the first speed gear pair side.

In consideration of installability of the vehicle power unit, it is preferable that the number of the gear pairs in the speed changer mechanism unit be two, as in this configuration. For example, when the number of gear pairs is set to five, six, or the like, since the physical size of the speed changer mechanism unit becomes excessively large, this is unfavorable. Since the one-way clutch is provided on the first speed gear pair side, in a case in which the power is transmitted via the gear pair, it is possible to avoid a situation in which the power is also transmitted via the one-way clutch (to avoid double gear meshing by the two paths described earlier) to guarantee the transmission efficiency of the power.

The vehicle power unit according to the aspect of this disclosure may be configured such that the gear pairs include a dog portion, and the switching unit includes an actuator portion which detects an instruction from the control unit and actuates and a sleeve portion which moves to freely engage and disengage with the dog portion through the actuation of the actuator portion.

With this configuration, it is possible to reliably actuate the switching unit based on an instruction of the control unit.

In the vehicle power unit according to the aspect of this disclosure, it is preferable that the control unit selects the auxiliary control in a case in which a temperature of the actuator portion is greater than or equal to a predetermined temperature.

With this configuration, since the control unit is configured such that the auxiliary control is forcedly selected when the control unit excessively executes the main control, excessive electrical power consumption does not occur, and as a result, it is possible to prevent a worsening in the fuel efficiency.

In the vehicle power unit according to the aspect of this disclosure, it is preferable that the control unit selects the auxiliary control in a case in which the vehicle-requested gear is a first speed gear and a vehicle speed is less than or equal to a predetermined speed.

With this configuration, since the control unit is configured such that the auxiliary control is selected in a case in which the vehicle speed is less than or equal to a predetermined speed, the control unit proceeds to step ST101 (ST101 in FIG. 6) onward.

In the vehicle power unit according to the aspect of this disclosure, it is preferable that, in the main control which is selected by the control unit, the control unit disposes the switching unit at the neutral position in a case in which the vehicle-requested gear is a first speed gear and the vehicle is in a running state, and the control unit disposes the switching unit at the position at which the switching unit engages with the gear pair that corresponds to the vehicle-requested gear in a case in which the vehicle-requested gear is the first speed gear and the vehicle is in a regenerative state, in a case in which the vehicle-requested gear is a second speed gear, or in a case in which the vehicle-requested gear is a reverse gear.

With this configuration, it is possible to efficiently separate the usage of the two paths, the general path which goes via the gear pair, and the bypass path which goes via the one-way clutch (it is possible to avoid the double gear meshing by the two paths described earlier). More specifically, it is possible to guarantee the transmission efficiency of the power by disposing the switching unit such that the power is not transmitted by a path which goes via the gear pairs in a case in which the power is transmitted by the bypass path (described earlier) which goes via the one-way clutch.

According to various embodiments, it is possible to provide a vehicle power unit which includes a speed changer mechanism unit which improves drivability and is compact overall by shortening a speed changing time without leading to a worsening in fuel efficiency.

Hereinabove, as described earlier, although various embodiments are exemplified, the embodiments are merely exemplary and are not intended to limit the scope of the embodiments disclosed here. Various other embodiments are possible and it is possible to make various omissions, substitutions, and modifications in a scope not departing from the spirit of the invention. It is possible to embody the invention by modifying, as appropriate, configurations, shapes, sizes, lengths, widths, thicknesses, heights, numbers, and the like.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle power unit comprising:
an electric motor;
an input shaft to which power of the electric motor is input;
an intermediate shaft to which the power from the input shaft is transmitted;
a drive shaft which is disposed parallel to the intermediate shaft, to which the power from the intermediate shaft is transmitted via a differential mechanism unit, and which transmits the power to drive wheels;
a speed changer mechanism unit which is disposed on a power transmission path from the input shaft to the drive shaft and which includes two or more gear pairs, a switching unit which moves to freely engage and disengage with the gear pairs, and a one-way clutch; and
a control unit which selects main control in which the control unit instructs the switching unit to cause the switching unit to be disposed at a neutral position in a case in which the power is transmitted via the one-way clutch and to cause the switching unit to be disposed at a position at which the switching unit engages with the gear pair that corresponds to a vehicle-requested gear in a case in which the power bypasses the one-way clutch and is transmitted, or selects auxiliary control in which the control unit instructs the switching unit to be forcedly disposed at a position at which the switching unit engages with the gear pair that corresponds to the vehicle-requested gear regardless of whether or not the power is transmitted via the one-way clutch.

2. The vehicle power unit according to claim 1,
wherein the gear pairs include a first speed gear pair and a second speed gear pair, and the one-way clutch is provided on the first speed gear pair side.

3. The vehicle power unit according to claim 1,
wherein the gear pairs include a dog portion; and
the switching unit includes an actuator portion which detects an instruction from the control unit and actuates and a sleeve portion which moves to freely engage and disengage with the dog portion through the actuation of the actuator portion.

4. The vehicle power unit according to claim 3,
wherein the control unit selects the auxiliary control in a case in which a temperature of the actuator portion is greater than or equal to a predetermined temperature.

5. The vehicle power unit according to claim 1,
wherein the control unit selects the auxiliary control in a case in which the vehicle-requested gear is a first speed gear and a vehicle speed is less than or equal to a predetermined speed.

6. The vehicle power unit according to claim 1,
wherein in the main control which is selected by the control unit, the control unit disposes the switching unit at the neutral position in a case in which the vehicle-requested gear is a first speed gear and the vehicle is in a running state, and
the control unit disposes the switching unit at the position at which the switching unit engages with the gear pair that corresponds to the vehicle-requested gear in a case in which the vehicle-requested gear is the first speed gear and the vehicle is in a regenerative state, in a case in which the vehicle-requested gear is a second speed gear, or in a case in which the vehicle-requested gear is a reverse gear.
